(19) United States
(12) Patent Application Publication
(10) Pub. No.: US 2007/0266864 A1
(43) Pub. Date: Nov. 22, 2007

(54) Microwave Cooking Container with Improved Lid Design

(76) Inventor: Gary Hopkins Sr, Punta Gorda, FL (US)

Correspondence Address: David W. Carrithers;Carrithers Law Office, One Paragon Centre, 6060 Dutchman's Lane, Suite 140, Louisville, KY, 40205, US

(21) Appl. No.: 10/573,664

(22) PCT Filed: May 12, 2004
(86) PCT No.: PCT/US04/14825

§ 371 Date: Apr. 16, 2007

Related U.S. Application Data
(60) Provisional application No. 60/507,195, filed on Sep. 29, 2003.

(51) Int. Cl. A47J 27/04

(52) U.S. Cl. 99/646 C

(57) ABSTRACT

A device for improving steam cooking of microwave food is described. A container 10 defines a compartment 22 for holding food. A first member 14 is sealed to a second member 16 to form the compartment 22 in the container 10. The members 14, 16 are composed of two different materials having different coefficients of thermal expansion. The members 14, 16 expand at different rates when heated forming a vent in the seal between the members 14, 16. The venting enables steam to escape at a gradual rate improving the steam cooking of the food.

### CROSS-REFERENCE TO RELATED APPLICATION

This application claims the benefit of U.S. Provisional Application No. 60/507,195, filed Sep. 29, 2003, which is incorporated herein by reference.

### BACKGROUND OF THE INVENTION

The present invention relates to the field of cooking devices, and, more particularly, to cooking containers for use in a microwave oven for cooking meats, vegetables, and other food products.

Consumers often prefer to cook food in a microwave oven rather than conventional ovens because of the reduced cooking time required to heat foods in a microwave oven. Consumers also want to be provided with the opportunity to cook pre-packaged food products in the package in which they were purchased without the hassle of transferring the food from one container to the next.

Unfortunately, foods cooked in a microwave oven tend to be tough and/or dry in texture and consistency, rather than tender and moist. When liquid is added to the food in an attempt to retain moisture, the food can become soggy and undesirable. In addition, microwave ovens do not evenly distribute heat to the product being cooked. This results in a cooked food product that may be very hot in one area, but cold in another area. Because of these problems, many people consider microwave cooking to be problematic and generally undesirable.

One method for improving the texture and consistency of food cooked in a microwave oven is to use steam generated by the heated food product to assist in cooking the food. Cooking with steam not only provides moisture for the food being cooked, but also results in more consistent heating throughout the food product.

Specifically, a container using the steam generated by the heated food product to assist in cooking the food takes advantage of the ideal gas law, a distillation of several kinetic theories including Boyle's Law and Gay-Lussac's Law. More specifically, such containers take advantage of the proportional relationship between pressure and temperature when volume and number of gas molecules remain constant. This proportional relationship can be expressed as a mathematical equation, (P2/P ) (T2/T,), where P, is the initial pressure, P2 is the final pressure, T, is the initial temperature, and T2 is the final temperature. Accordingly, any increase in pressure will result in a proportional increase in temperature that would not occur at ambient pressures. For example, if the pressure was to increases 1.2 fold (e.g., from 1 to 1.2 atmospheres), the temperature would also increase 1.2 fold (e.g., from 275 K to 330 K, which is an increase from 35° F. to 134° F.).

In order to steam cook a food product in a microwave oven, the steam must be retained within a cooking container; accordingly, the container must be at least partially sealed. When a sealed container is used to heat a food product contained therein, pressure rapidly builds as steam is generated from the heated food product. As heating continues, this pressure will continue to escalate until the container ruptures in some fashion, thereby relieving the pressure.

This relief often comes in the form of an explosion forcing an opening of the container and resulting in food being ejected therefrom. Not only does such an explosion create a mess, but it also undermines the attempt to use steam to cook the food product because the explosion causes a rapid release of the collected steam from the no longer sealed cooking environment.

It is therefore the paramount object of the present invention to provide a microwave cooking container with a lid design that allows for controlled venting of the container.

This and other objects and advantages of the present invention will become apparent upon a reading of the following description.

### DESCRIPTION OF THE DRAWINGS

FIG. 1 is a perspective view of a microwave cooking container with a lid, which allows for controlled venting of the container, made in accordance with the present invention.

### DETAILED DESCRIPTION OF THE INVENTION

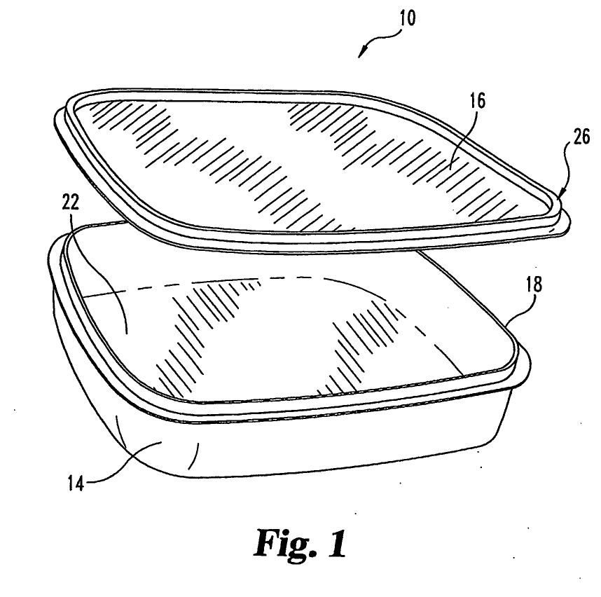

The present invention is a microwave cooking container 10 for steam cooking food product. With reference to FIG. 1, the container 10 generally includes a base 14, having at least one compartment 22, and a lid 16. Because the container 10 is being used to steam cook a food product, the steam must be retained within a container 10 while the food product is being prepared; accordingly, the container 10 must have a sealed cooking environment. A sealed cooking environment is one which has a substantially fixed volume. Specifically, after food product has been delivered to the compartment 22, the lid 16 is sealed to the base 14, thereby substantially fixing the volume of the container 10.

There are various manners in which the lid 16 may be sealed to the base 14. For example, the base 14 could be a substantially rigid tray, and the lid 16 could be snap-on lid. Specifically, in the embodiment of the container 10 depicted in FIG. 1, the base 14 includes a rim 18 and the lid 16 includes a channel 26 adapted to snuggly receive the rim 18 of the base 14, thereby sealing the lid 16 to the base 14 and creating a substantially fixed volume within the container 10. Of course, the embodiment depicted in FIG. 1 is merely exemplary and it is contemplated that a variety of bases and lids may be used without departing from the spirit and scope of the present invention.

The container 10 of the present invention is designed to maintain the fixed volume while being heated such that pressure builds within the volume, allowing for efficient steam cooking of the food product. However, as heating continues, this pressure will continue to escalate until the pressure is relieved. Without a controlled venting mechanism, this relief would come in the form of an explosion forcing the covering from the base of the container, result in food being ejected from the container. The container 10 of the present invention avoids this problem by controlling the venting of the steam and the release of pressure.

First, it is important to recognize that the physical properites of a material give certain indications of the manner in which that material will respond to certain conditions. For example, the Coefficient of Thermal Expansion (CTE) of a material will provide an indication of how the length of the material will change in response to being heated, specifically, the change in length per unit length per unit rise in temperature. The CTE of a material can be calculated using the following formula: CTE=(ΔL)/[(L₀)(ΔT)], where ΔL is the change in length, L₀ is the original length before heating, and ΔT is the change in temperature.

The higher the CTE, the greater the degree with which the material expands when it is subjected to heat. To exemplify this correlation, generally speaking, polymers have a CTE which is approximately 5 to 10 times higher than that of metals, reflecting the greater degree with which polymers expand in response to being heated, as compared to metals. Polymers also have CTEs which vary from one another, reflecting the varying degrees with which different polymers expand when subjected to heat. For example, certain polypropylenes have a CTE of approximately 60×10⁻⁶ to 110×10⁻⁶K⁻¹ (0.00006 to 0.00011 K⁻¹) while polyester terephthalate (PET) has a CTE of approximately 20×10⁻⁶ to 80×10⁻⁶ K⁻¹ (0.00002 to 0.00008 K⁻¹), where K is Kelvin. As such, when subjected to the same amount of heat, polypropylenes expand more than PET.

With respect to the controlled venting of the container 10 of the present invention, the materials with which the container 10 is constructed are specifically chosen, not only because they are transparent to radiant energy, such as energy from a microwave oven, but also for their ability to allow for controlled venting. Specifically, the lid 16 and the base 14 of the present invention are constructed from materials having different CTEs. For example, and with reference to FIG. 1, the base 14 of the present invention may be constructed from a first material, such as crystallized polyester terephthalate (C-PET), having a CTE which is less than that of a second material, such as polypropylene, from which the lid 16 may be constructed. As such, the channel 26 of the lid 16 would expand more rapidly than the rim 18 of the base 14, which originally fit snuggly within the channel 26, thereby breaking the seal between the lid 16 and the base 18 and allowing the container 10 to vent in a controlled manner.

Pairs of materials may be chosen for their varying CTE differentials. The greater the differential, the less heat which must be applied before venting occurs. In this manner, the container 10 may be customized to provide an optimum cooking environment for an optimum period of time for a particular food type. It is additionally contemplated that the base 14 of the container could include multiple compartments 22, each compartment having an associated lid 16 and each lid 16 being constructed from a material having a different CTE, allowing venting from the various compartments 22 of the container 10 to occur at various times.

It is further contemplated that a custom designed lid 16 could be made for an existing base 14 such that the custom designed lid 16 could be sealed to the existing base 14, the custom designed lid 16 being constructed from a material having a CTE which is different than that of the existing base 14 to allow for controlled venting.

Although it is not necessary, it is preferred that the container 10 of the present invention additionally include one or more venting assemblies (not shown) designed to specifically urge the seal between the base 14 and the lid 16 to be broken at one or more predetermined location to allow for further control over the venting of the container 10 of the present invention. For example, the venting assembly (not shown) may include at least one lifter, which is a substantially V-shaped indentation along the top of the rim 18 of the base 14 with the “V” ending before the outer edge of the rim 18, thus creating a weakened portion in the seal, at which portion venting will preferentially initiate.

It will be obvious to those skilled in the art that other modifications may be made to the invention described herein without departing from the spirit and scope of the present invention.

1. An improved device for steam cooking a food product comprising:
a container defining a compartment for holding food, the container including a first member sealed to a second member to define the compartment, wherein the first member has a coefficient of thermal expansion that is different than the coefficient of thermal expansion of the second member, wherein the heating of the members forms a vent in the seal between the first member and the second member.

2. The device of claim 1, wherein the first member is a base.

3. The device of claim 1, wherein the second member is a lid.

4. The device of claim 2, wherein the base defines a plurality of compartments.

5. The device of claim 2, the base including a bottom surface and four side surfaces defining a box like shape with an open top.

6. The device of claim 5, the side surfaces including a rim formed around the periphery of a top edge of the four side surfaces.

7. The device of claim 3, wherein the lid is substantially planar.

8. The device of claim 7, wherein the lid further defines a channel constructed and arranged to form a seal when the lid is coupled with the first member.

9. The device of claim 1, wherein the members are composed of a polymer.

10. The device of claim 2, wherein the base is composed of a crystallized polyester terephtalate.

11. The device of claim 3, wherein the lid is composed of polypropylene.

12. The device of claim 4, including a plurality of second members constructed and arranged to cover the plurality of compartments defined by the base.

13. The device of claim 12, wherein the second members are composed of materials having different coefficients of thermal expansion.

14. The device of claim 1, including venting assemblies to assist in breaking the seal between the first member and the second member.

15. The device of claim 14, wherein the first member is a base having a rim and the venting assembly is a V-shaped indentation along the top of the rim.
